(19) United States
(12) Patent Application Publication
(10) Pub. No.: US 2010/0128243 A1
(43) Pub. Date: May 27, 2010

(54) COMPACT COLLIMATOR LENS FORM FOR LARGE MODE AREA AND LOW NUMERICAL APERTURE FIBER LASER APPLICATIONS

(75) Inventors: Lionel D. Liebman, Plano, TX (US); Ronald E. Janka, Grapevine, TX (US)

Correspondence Address: WILLIAMS, MORGAN & AMERSON, 10333 RICHMOND, SUITE 1100, HOUSTON, TX, 77042, US

(73) Assignee: Lockheed Martin Corporation

(21) Appl. No.: 12/623,739

(22) Filed: Nov. 23, 2009

Related U.S. Application Data
(63) Continuation of application No. 11/283,369, filed on Nov. 18, 2005, now abandoned.

(51) Int. Cl. G02B 6/32; G02B 27/30; G01C 3/00; H01S 3/30

(52) U.S. Cl. 356/3; 385/33; 359/641; 359/641; 372/6

(57) ABSTRACT

A lens form includes a length of optical fiber terminated on at least one end thereof; a negative optical element optically aligned with the terminated end of the optical fiber; and a positive optical element optically aligned with the negative optical element.

### BACKGROUND OF THE INVENTION

1. Field of the Invention

The present invention pertains to fiber laser-based systems, and, more particularly, to large mode area, low numerical aperture fiber laser applications.

2. Description of the Related Art

Many military and civilian applications rely on optical techniques such as laser detection and ranging (“LADAR”) or directed energy (“DE”) techniques. Both of these types of techniques employ a focused, coherent optical signal, such as a laser. Both of these techniques also find use in high performance or otherwise demanding applications, although the contexts for those applications may vary widely. These contexts are frequently military, but many are civilian. For instance, these types of optical systems are used in terrain mapping; construction site surveying and monitoring; autonomous vehicle navigation; hazardous environment control; industrial laser machining, welding, and manufacturing process control; remote sensing; free space optical communications; and medical and dental diagnostic imaging.

Many high performance applications for, e.g., LADAR and DE techniques, incorporate demanding design constraints. Conventional lasers and optics for conditioning and transmitting the laser signal can be bulky and heavy. Most high performance applications not only have tight requirements for low weight and small bulk, but also high power. The requirement for high power generally exacerbates the weight and bulk issues, as well. Thus, the search for alternatives to conventional lasers and optics continues.

One approach employs a fiber laser to mitigate some of these problems. Fiber lasers are, generally, lighter, more compact, lower heat, self-aligning, and more energy efficient than the conventional lasers used in these type applications. A fiber laser is generally an optical fiber doped with substances that, when appropriately excited, acts as a waveguide, amplifies and emits a laser signal. For example, a fiber laser may be a Germanium (Ge) doped double-clad fibers made “active” by doping the core with gain materials (e.g., Ytterbium or Erbium) that when excited by pump energy in the clad amplifies a seed laser signal. Selection of the dopants depends on the output wavelength of interest. For instance, Erbium is used for 1550 nm whereas Ytterbium is used for 1064 nm. The injection of pump light in the cladding of the double-clad actively doped fiber amplifiers serves as the excitation method. Dopant concentrations, pump power, and length of active fiber determine the resulting gain. The only electrical energy used is to drive seed diode and pump diodes. For operational reasons, the output end of the fiber laser is usually fused to a piece of compatible inactive fiber (i.e., only doped with Ge and not doped with a gain material) that is “mode coupled.” The laser signal is then delivered from the fiber laser through the mode coupled delivery fiber.

However, current fiber lasers and mode coupled fiber delivery approaches are limited either in their power tolerance (i.e., laser induced damage threshold, or “LIDT”) or laser beam quality (e.g., times diffraction limit, or M²) because they tend to rely on a single fiber optic channel. For example, a conventional single mode optical fiber has a very small mode field diameter, and therefore, higher energy densities at its fiber/air interface and lower LIDT. Increasing the mode field diameter without limiting the number of guided modes may improve LIDT, but it increases output M² reducing delivered beam quality.

Current fiber lasers use low numerical aperture (“NA”), large mode area (“LMA”) delivery fibers to meet the most stringent time diffraction limit (M²) beam quality requirements. Lowering the NA limits the number of guided modes to just a few in order to achieve single mode like output (M²=1) where NA=(n1²−n2²)^{1/2}, n1 is the core refractive index, and n2 is the cladding refractive index. In order to have a fiber optic waveguide n1>n2; so, NA describes the difference in density between core and clad. This creates a physical limit to how low a NA one can achieve without losing waveguide properties. And, the lower the NA, the longer the focal length collimator required to collimate a large beam for minimizing the divergence for Ladar, DE, etc. type applications. The longer the focal length, the more volume that is required in a conventional collimator approach. Increasing mode field diameter reduces non-linear effects and increases power tolerance.

Termination of these delivery fibers is usually done with an end-cap and a positive singlet. This approach cannot satisfy most tactical packaging constraints for demanding LADAR and directed energy because its optical path is too long, requiring additional bulk optics. The longer optical path also makes conventional collimators more temperature sensitive and sensitive to optical alignment issues.

Another factor in the performance of these optical systems is the “lens form.” A lens form is a lens design type. A lens form is usually identified by its shape or purpose and each lens form carries certain optical imaging characteristics. Thus, lens forms are categorized based on their purpose and are the result of optimizing to satisfy various combinations of aperture and field of view. No single optical design can satisfy all constraints. Furthermore, an optical design is optimum for only one set of constraints. However, similar applications will trend toward the same lens form as the optimum solution.

The fiber optic collimator lens forms conventionally used with fiber lasers are significantly impacted by the issues discussed above. In general, a lens form is of arbitrary dimension a can be scaled or modified to satisfy specific application requirements. However, certain physical characteristics of the lens form are not scalable beyond certain limits. For instance, the focal length of the lens form will be largely a function of the output numerical aperture of the fiber laser. It will simply take a certain distance for the laser signal to diverge sufficiently for it to then be collimated for conditioning and transmission. This is unfortunate, because many LADAR systems prize small size in addition to lightweight.

The present invention is directed to resolving, or at least reducing, one or all of the problems mentioned above.

### SUMMARY OF THE INVENTION

The present invention is, in its various aspects and embodiments, a compact collimator lens form. The lens form generally comprises a length of optical fiber terminated on at least one end thereof; a negative optical element optically aligned with the terminated end of the optical fiber; and a positive optical element optically aligned with the negative optical element. In one embodiment, the lens form comprises an endcap; a length of optical fiber terminated at one end thereof by the endcap; a negative lens optically aligned with the optical fiber output path; and a positive lens optically aligned with the negative lens. In another embodiment, the lens form comprises an endcap having a concave face formed in a first end thereof; a length of optical fiber terminated at one end thereof by affixation to a second end of the endcap; and a positive lens optically aligned with the output path of the optical fiber.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first embodiment of a lens form constructed in accordance with the present invention;

FIG. 2 conceptually illustrates an optical apparatus employing the lens form of FIG. 1;

FIG. 3 illustrates one particular embodiment of a method practice in accordance with the present invention;

FIG. 4 conceptually illustrates a second embodiment of a lens form constructed in accordance with the present invention;

FIG. 5 conceptually illustrates an optical apparatus employing the lens form of FIG. 4;

FIG. 6A-FIG. 6C illustrate one particular application for the lens form FIG. 1 namely, a LADAR apparatus, in which:

FIG. 6A is a perspective view of the LADAR apparatus;

FIG. 6B is a perspective, isolation of the LADAR transmitter of the LADAR apparatus in FIG. 6A; and

FIG. 6C is an optical ray trace of the LADAR transmitter in FIG. 6B;

FIG. 7-FIG. 12 graphically present selected performance characteristics for the optical apparatus of the LADAR transmitter of FIG. 6B-FIG. 6C in which:

FIG. 7-FIG. 8 illustrate the output surface, on-axis and off-axis footprints, respectively, with Gaussian apodization;

FIG. 9A-FIG. 9F illustrate the far-field geometrical optical path difference (“OPD”);

FIG. 10A-FIG. 10F this is a diffraction encircled energy plot representing the far field divergence in microradians and includes divergence due to geometrical aberrations as well as diffraction effects related to the output beam size;

FIG. 11 illustrates the far-field half-angle divergence in microradians; and

FIG. 12 illustrates the on-axis wave front error at wavelengths of 1064 nm.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 illustrates a first embodiment of a lens form 100 constructed in accordance with the present invention. The lens form 100 comprises an endcap 103, a length of optical fiber 106, a negative lens 109, and a positive lens 112. The optical fiber 106 is terminated at one end 115 thereof by the endcap 103. The negative lens 109 is optically aligned with the optical fiber 106 output path such that a laser signal 118 propagating through the optical fiber 106 and endcap 103 impinges on the negative lens 109. The positive lens 112 is optically aligned with the negative lens 109 so that the laser signal 118 propagates through the negative lens 109 and impinges on the positive lens 112.

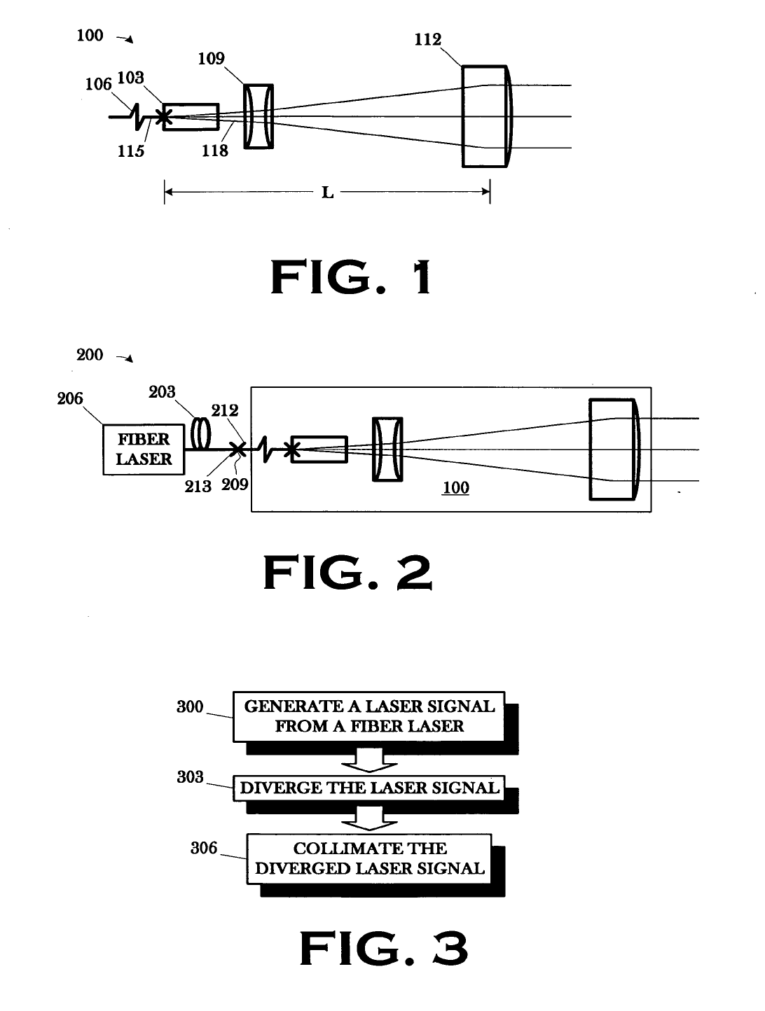

The length of optical fiber 106 comprises, in the illustrated embodiment, a low NA, LMA fiber. It can therefore be fused directly to the delivery fiber of a fiber laser. Consider, for instance, the optical apparatus 200 shown in FIG. 2. FIG. 2 illustrates the lens form 100 affixed to the delivery fiber 203 of a fiber laser 206 by a fusion splice 209. A “delivery fiber”, as is known in the art, is generally a doped (e.g., with Germanium) optical fiber. The fusion splice 209 may be formed by, for example, melting the ends 212, 213 and then joins the melted ends 212, 213 before they cool and solidify again. Since laser fusion techniques are well known to the art, further information regarding the same shall be omitted so as not to obscure the present invention.

A variety of splicing techniques for optical fibers are known in various arts. Laser fusion techniques typically are performed in a manufacturing facility. This nullifies one advantage of the illustrated embodiment. The illustrated embodiment is a pigtail, and is therefore amenable to use as a line replaceable unit for repairs or retrofits in the field. Thus, the fusion splice 209 may be formed using field techniques employed in, for example, the telecommunications art. Such fusion techniques include arc fusion splicing and filament fusion splicing. Thus, some embodiments may be deployed as line replaceable units. This aspect of the present invention also facilitates future upgrades in fiber laser or sensor technology in optical systems.

It will be apparent to those skilled in the art having the benefit of the disclosure that the invention admits some variation in the implementation of the optical fiber 106. As in the illustrated embodiment, the optical fiber 106 may be an ordinary length of low NA, LMA optical fiber. Alternatively, the optical fiber 106 might be a spliced combination of a low NA, LMA optical fiber and a mode coupled delivery fiber. Or, the endcap 103, shown in FIG. 1, might be affixed directly to the mode coupled delivery fiber such that the optical fiber 106 consists of a delivery fiber. The invention is not limited by this aspect of implementation although these considerations may be significant in individual embodiments.

Referring again to FIG. 1, the endcap 103, negative lens 109, and positive lens 112 may be implemented using conventional, off-the-shelf components well known to the art that are readily and commercially available. The invention also admits variation in this aspect of the invention. For instance, the negative lens 109 of the illustrated embodiment is an equi-concave lens, but the invention is not so limited. An equi-concave lens has some advantages, however. For instance, during assembly, it makes no difference the orientation of the negative lens 109 so long as it is properly optically aligned. This promotes reliability in the finished product by reducing assembly errors and eases the level of training required of assembly technicians. However, other types of negative optical elements may also be used in alternative embodiments. The positive lens 112 in the illustrated embodiments is similarly a plano-convex lens, although other types of positive optical elements may be used.

Referring now to FIG. 1-FIG. 3, in operation, the fiber laser 206 generates (at 300, FIG. 3) a laser signal 118 in conventional fashion that is delivered through the delivery fiber 203 to the lens form 100. The laser signal 118 is received (at 302, FIG. 3) at the lens form 100. The laser signal 118 propagates from the endcap 103 to impinge on the negative lens 109. The negative lens 109 diverges (at 303, FIG. 3) the laser signal 118 in the lens form 100 to reduce the overall length thereof. The diverged laser signal 118 then impinges upon the positive lens 112, which then collimates it (at 306, FIG. 3).

The focal length f of the lens form 100 is approximately twice the length L, shown in FIG. 1—i.e., the distance from the focus or back of the endcap 109 to the front vertex of the positive lens 112. In conventional lens forms, the focal length f, shown in FIG. 1, for the positive lens 112 is a function of the divergence of the laser signal 118. Thus, by introducing the divergence created by the negative lens 109, the present invention accelerates the divergence of the laser signal 118 relative to what is found in conventional systems. This reduces the focal length f for the present invention relative to conventional systems. One particular embodiment halves the focal length f. Thus, this aspect of the present invention reduces the size of the lens form 100 by reducing the length L thereof and facilitates the long focal length required for a big beam in a shorter package. This also has other salutary effects such as reducing temperature and alignment sensitivities that will increase manufacturing and operational reliability.

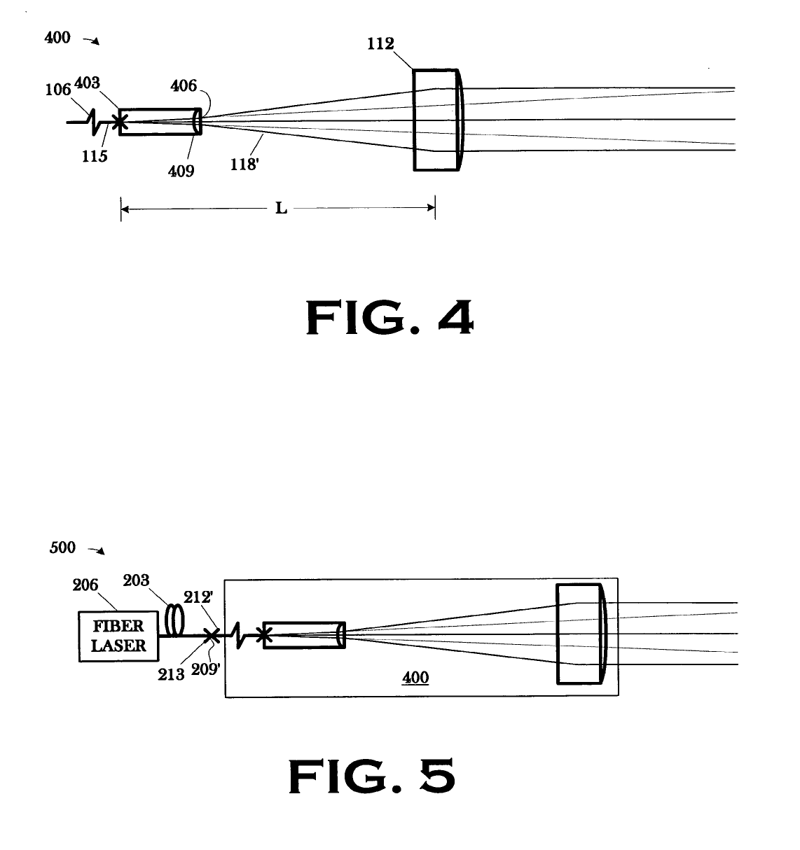

Note that there may be alternative ways in which to introduce this accelerated divergence, and so the present invention admits variation in the structure of the lens form. Consider FIG. 4, which illustrates a second embodiment of a lens form 400 constructed in accordance with the present invention. In this particular embodiment, the endcap 103 and negative lens 109 of the lens form 100, shown in FIG. 1, are replaced by a negative endcap 403. The negative endcap 403 is the same as the conventional endcap 103, except that it is fabricated with a concave face 406 on the output end 409 thereof.

As those in the art having the benefit of this disclosure will appreciate, conventional endcaps such as the endcap 103 are typically comprised of a Silica pellet or a large multimode silica fiber with a large core and no cladding. The Silica pellet is polished flat on each end, and one flat, polished end is then fused to an optical fiber. This generally describes the fabrication of the endcap 103 and its affixation to the optical fiber 106 in FIG. 1. The negative endcap 403 can be fabricated in a similar manner, except that instead of polishing the end 409 flat, the concave face 406 is instead polished.

The lens form 400 shown in FIG. 4 reduces part counts even relative to the lens form 100 of FIG. 1. This concomitantly carries additional reduction in temperature and alignment sensitivities that will further increase manufacturing and operational reliability. The lens form 400 does have one additional advantage over the lens form 100 in that the concave face 406 reduces back reflection, and thus back scattering from such back reflection. Reduced back scatter is a significant improvement not only for high energy laser applications, but also for bi-directional systems employing fiber lasers such as LADARs, coherent heterodyne, or DE monitoring sensors, for example. This isolates the receiver from undesirable reflection events (or false alarms) that would otherwise occur in the transmit path of a bidirectional system.

The lens form 400 is also, like the lens form 100 in FIG. 1, a low NA, LMA fiber pigtail. To illustrate how this lends itself to modularity in the manner described above, a second embodiment of an optical apparatus 500, in which the lens form 400 is affixed to the delivery fiber 203 and the fiber laser 206. The affixation is by a fusion splice 209′ between the end 213 of the delivery fiber 203 and the end 212′ of the optical fiber 106. The fusion splice 209′ may be formed as described above for the fusion splice 209. Note the desirability of field splicing techniques in this respect.

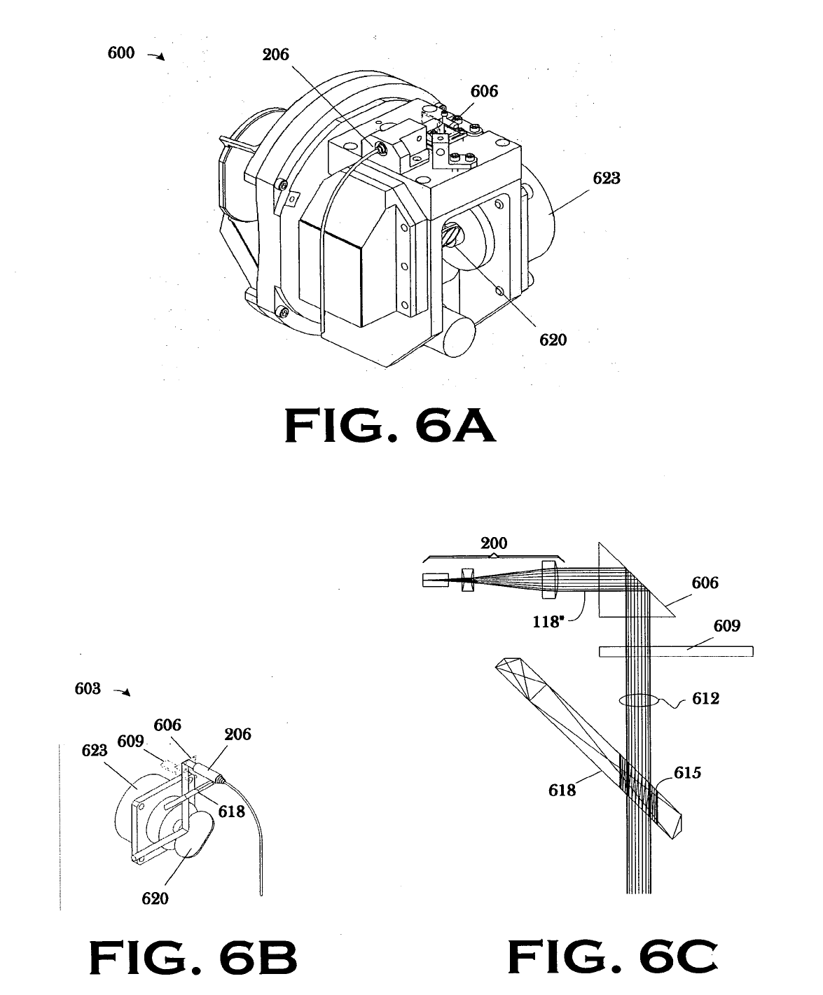

FIG. 6A-FIG. 6C illustrate one particular application for the lens form 100 of FIG. 1—namely, a LADAR apparatus 600. The particular LADAR apparatus 600 is a LADAR seeker intended for use on airborne vehicles, such as a guided submunition, an unmanned airborne vehicle (“UAV”), or a missile. FIG. 6A is a perspective view of the LADAR apparatus 600. FIG. 6B is a perspective, isolation of the LADAR transmitter 603 of the LADAR apparatus 600. FIG. 6C an optical ray trace of the LADAR transmitter 603 and conceptually illustrates its operation.

More particularly, the LADAR apparatus 600 is a gimbaled LADAR system. One type of LADAR system employs what is known as a “scanned illumination” technique for acquiring data. More technically, a LADAR transceiver aboard a platform transmits the laser signal to scan a geographical area called a “scan pattern”. The laser signal is typically a pulsed, split-beam laser signal. The LADAR transceiver aboard the platform transmits the laser signal. The laser signal is continuously reflected back to the platform, which receives the reflected laser signal. Note, however, that some implementations employ a continuous beam, an unsplit beam, or a continuous, unsplit beam.

Each scan pattern is generated by scanning elevationally, or vertically, several times while scanning azimuthally, or horizontally, once within the field of view for the platform. Thus, each scan pattern is defined by a plurality of elevational and azimuthal scans. The principal difference between the successive scan patterns is the location of the platform at the start of the scanning process. An overlap between the scan patterns is determined by the velocity of the platform. The velocity, depression angle of the sensor with respect to the horizon, and total azimuth scan angle of the LADAR platform determine the scan pattern on the ground. Note that, if the platform is relatively stationary, the overlap may be complete, or nearly complete.

The platform typically maintains a steady heading while the laser signal is transmitted at varying angles relative to the platform's heading to achieve the scans. The optics package of the LADAR transceiver that generates and receives the laser signal is typically “gimbaled”, or mounted in structure that rotates relative to the rest of the platform. Exemplary gimbaled LADAR transceivers are disclosed in:
U.S. Pat. No. 5,200,606, entitled “Laser Radar Scanning System,” issued Apr. 6, 1993, to LTV Missiles and Electronics Group as assignee of the inventors Nicholas J. Krasutsky, et al.; and
U.S. Pat. No. 5,224,109, entitled “Laser Radar Transceiver,” issued Jun. 29, 1993, to LTV Missiles and Electronics Group as assignee of the inventors Nicholas J. Krasutsky, et al.
   However, there are many alternatives known to the LADAR art.

The exemplary gimbaled LADAR systems disclosed in the patents listed above, as well as others known to the LADAR art, may be modified to accommodate the present invention. The LADAR apparatus 600 is, in fact, a modification of the seeker head set forth in the listed patents. Note that the gimbal has been omitted from FIG. 6A-FIG. 6C. The LADAR apparatus 600 employs the optical apparatus 200 first shown in FIG. 2, but alternative embodiments may employ others, e.g., the optical apparatus 500 shown in FIG. 5.

Referring now to FIG. 6B-FIG. 6C, the collimated laser signal 118″ output by the optical apparatus 200 is turned by a conventional, commercially available, total internal reflection prism 606. The turned laser signal 118″ next passes through a beam segmenter 609 for dividing the laser signal 118″ into a plurality of beam segments 612, also sometimes referred to as beamlets, arrayed on a common plane, initially overlapping, and diverging in a fan shaped array. In the illustrated embodiment, the laser signal 118″ is split into 9 beamlets. The divergence of the segmented beamlets 612 is not so great as to produce separation of the beams within the LADAR apparatus 600, but preferably is sufficiently great to provide a small degree of separation at the target, as the fan-shaped beam array is scanned back and forth over the target.

The beamlets 612 then pass through an aperture 615 of an apertured mirror 618, and subsequently reflected from a scanning mirror 620 in a forward direction relative to the platform (not otherwise shown). The apertured mirror 615 acts as a passive optical switch for the optical transceiver—that is, it allows outgoing transmit beams and incoming return beams to share a common gimbal and elevation scanning mechanisms and telescope. The aperture 615 is located off the center of the aperture mirror 618. The scanning mirror 620 is pivotally driven by a scanning drive motor 623, which is operable to cyclically scan the beamlets 912 for scanning the target area. In a preferred embodiment, the beamlets 612 are preferably scanned at a rate of approximately 100 Hz. The scanning mirror 620 scans the beamlets 612 in elevation while the operation of the gimbal (not shown) scans them in azimuth.

A comparison of FIGS. 6A-6C and the seeker heads disclosed in the patents referenced above will reveal how the present invention results in a smaller, lighter, and more compact LADAR apparatus. Such a comparison will also reveal that the optical path is much simpler, yielding the reduction in temperature and alignment sensitivities discussed above. Note, too, that the LADAR sensor receives the laser signal from the laser in a direction transverse to the direction in which it transmits a LADAR signal.

As noted above, the LADAR apparatus 600 of FIG. 6A-FIG. 6C employs one particular implementation of the optical apparatus 200, shown in FIG. 2, which includes the lens form 100 of FIG. 1. The LADAR apparatus 600 is a low duty cycle, pulsed “laser range finder” at 1064 nm. Table 1 sets forth selected fiber input laser source characteristics. Irradiance levels in the bulk fiber materials may reach/exceed values of 14 GW/cm2 based upon a 20 micron core fiber.

TABLE 1
Selected Fiber Input Laser Source Characteristics

| | | |
|---|---|---|
| | Minimum | Maximum |
| Parameter | Value | Value |

| | |
|---|---|
| Central Wavelength [nm] | 1064 |
| Spectral Line width FWHM [nm] | 1.0 |

| | | |
|---|---|---|
| Energy Per Pulse [mJ] | 0.1 | 0.35 |
| Pulse Length FWHM [nsec] | 8 | 12 |
| Pulse Repetition Rate [kHz] | 20 | 50 |
| Number of Pulses | 36 × 10⁶ | 90 × 10⁶ |

Table 2 sets for the selected specifications for optical requirements. In Table 2, with respect to insertion loss, a measurement T of throughput transmittance of T>95% should be acceptable. Note that output beam quality (M²) will depend to some degree on fiber and laser source mode coupling. In general, MIL or Telcordia spec in terms of construction and processes is preferred for this particular implementation and coefficient of thermal expansion (“CTE”) matched and Near Infrared (“IR”) transmissive materials are used when possible. CTE impacts both performance over operational temperatures as well as end of life requirements as dissimilar or CTE mismatched materials will tend to have thermal instabilities as well as reliability issues.

TABLE 2
Selected Optical Requirements at 1064 nm

| | Minimum | Maximum |
|---|---|---|
| Parameter | Value | Value |
| Insertion Loss [dB]* | — | 0.2 |
| Fiber/Pellet Interface Reflectance [dB] | — | −60 |
| Total Reflectance [dB] | — | −55 |
| Nominal Output Beam 1/e² Full Angle | — | 0.6 |
| Divergence by Design [mrads] | | |
| Maximum Output Beam 1/e² Full Angle | — | 0.7 |
| Divergence with Temperature [mrads] | | |
| Output Beam 1/e² Diameter [mm] | 3.0 | 4.0 |
| Output Beam Pointing Error [degrees] | — | 0.5 |
| Output Beam Offset Decenter [mm] | — | 0.7 |
| Output Beam Quality, M² | — | 1.5 |
| Operating Temperature [° C.] | −20 | +60 |
| Storage Temperature [° C.] | −40 | +85 |
| Non-Condensing Relative Humidity [%] | 0 | +85 |

The overall envelope for the optical apparatus 200 has a length <1.537″ (39 mm) and outer diameter <0.394″ (10 mm). A lightweight 3 mm stainless steel armored jacket for fiber protection and strain relief and minimum package length may be used. The application holds fiber bend radius to greater than 1.5″, so a rubber boot may be desirable for additional strain relief and reduced fiber bend sensitivity. The optical fiber 106 has a length between 1 and 2 meters. Table 3 sets forth commercially available components for the construction of the lens form 100 in this implementation. For high power tolerance, an epoxy-free optical path is utilized. Epoxies are only used to retain components or provide strain relief. To prevent contaminants from critical internal optical surfaces, the packaging is sealed.

TABLE 3
Commercially Available Components for Lens Form Construction

| Component | Part |
|---|---|
| Optical fiber | Nufern LMA-GDF-20/400 (core/clad in microns), |
| | LMA-GDF-20/125, and Nufern LMA-GDF-25/250, all |
| | with a numerical aperture of 0.06 ± 0.01 |
| Endcap | Standard T5364 silica pellet (or equivalent) |
| Negative lens | BK7 −4.0 mm EFL JML CBV11000 equiconcave |
| | (or equivalent) |
| Positive lens | Standard GPX-5-12.5 gradium plano-convex |
| | (or equivalent) |

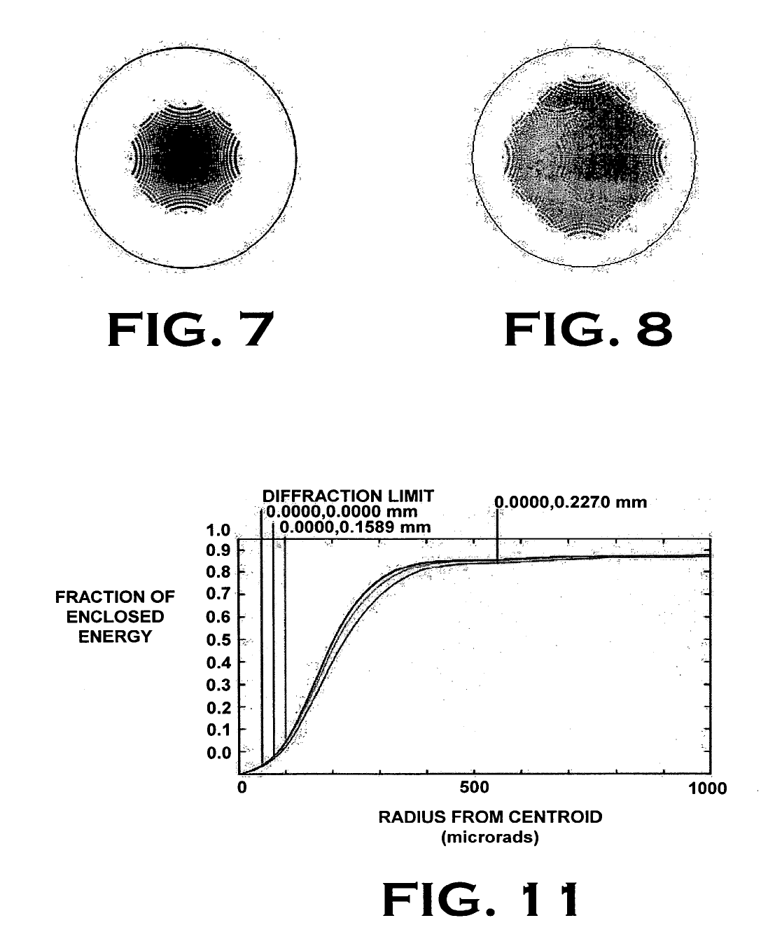

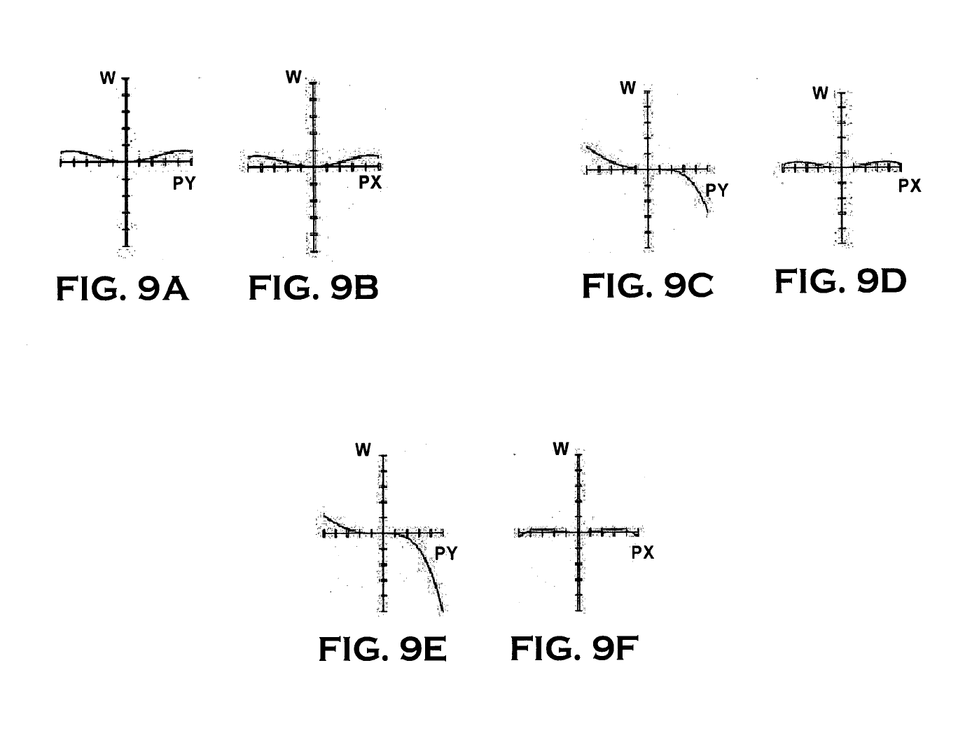

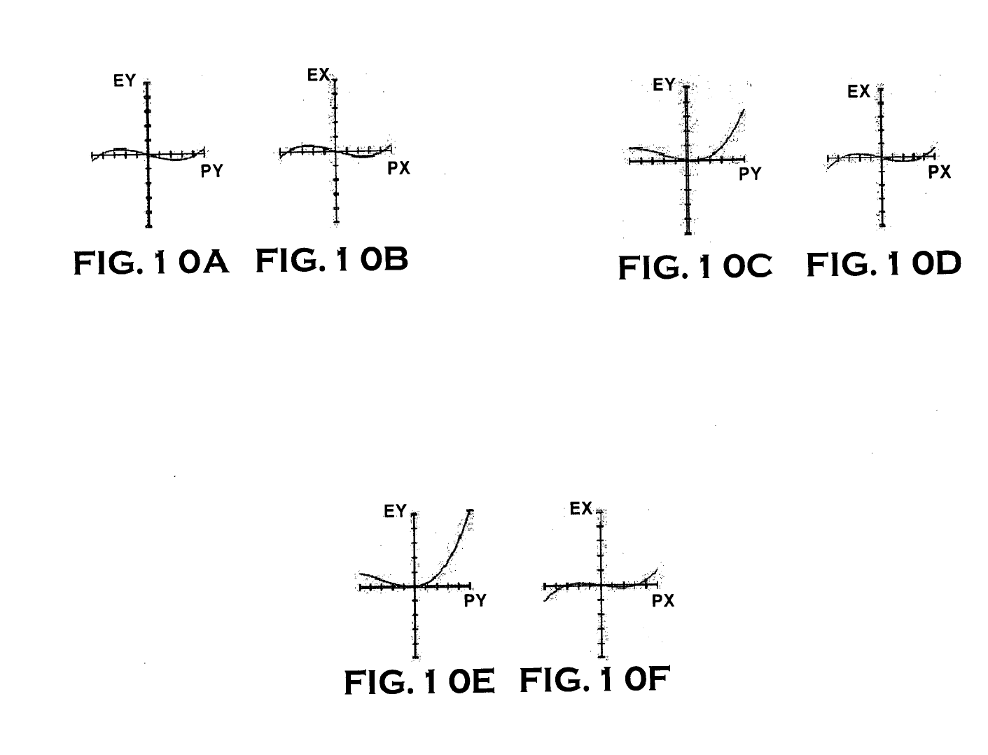

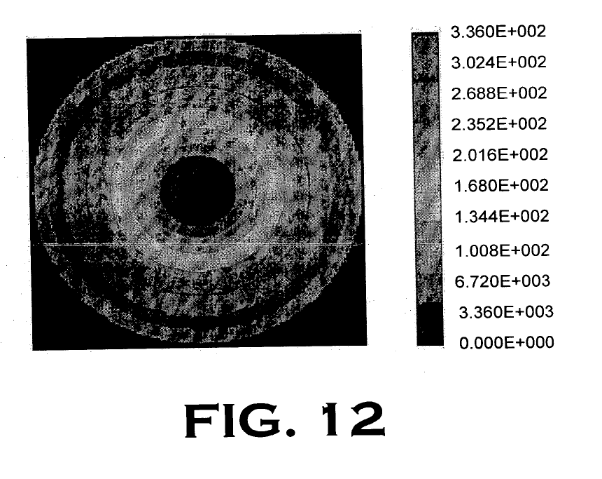

Additional performance characteristics are graphically presented in the attached drawings. FIG. 7 and FIG. 8 illustrate the output surface, on-axis and off-axis footprints, respectively, with Gaussian apodization. FIG. 9A-FIG. 9F illustrate the far-field geometrical optical path difference (“OPD”) in waves (λ=1064 nm) at 0.0 (FIG. 9A-FIG. 9B), 0.7 (FIG. 9C-FIG. 9D), 1.0 (FIG. 9E-FIG. 9F) relative field heights, assuming telecentric input fiber positions (a/k/a object heights or x,y lateral coordinates) of (0.0000 mm, 0.0000 mm), (0.0000 mm, 0.1589 mm) and (0.0000 mm, 0.2270 mm), respectively. FIG. 10A-FIG. 10F this is a diffraction encircled energy plot representing the far field divergence in microradians and includes divergence due to geometrical aberrations as well as diffraction effects related to the output beam size in mrad at 0.0 (FIG. 10A-FIG. 10B), 0.7 (FIG. 10C-FIG. 10D), 1.0 (FIG. 10E-FIG. 10F) relative field heights, assuming telecentric input fiber positions of (0.0000 mm, 0.0000 mm), (0.0000 mm, 0.1589 mm) and (0.0000 mm, 0.2270 mm), respectively. To simulate field dependence or off-axis performance, object heights were defined within the 0.5° allowable pointing error—where the fiber input radial displacement, h, on the endcap is a primary driver for pointing angle where h=f tan θ. FIG. 11 illustrates the far-field half-angle divergence in μrad at 0.0, 0.7, 1.0 relative field heights. Encircled energy includes geometrical errors and diffraction effects . . . again demonstrating near diffraction limited performance with 1/e² (86.5%) encircled energy in half angle divergence radius of ˜300 μrads (or ˜600 μrads full angle divergence). Finally, FIG. 12 illustrates the on-axis wave front error in waves (λ=1064 nm).

Note that, in the LADAR apparatus 600 in FIG. 6A, the fiber laser 206 is removed off the gimbal although this is not expressly shown. For technical reasons, the entire optics package in conventional LADAR systems is typically gimbaled. More particularly, in conventional systems, the components that comprise the optical train through which the laser signal is generated and transmitted must be optically aligned. This optical alignment cannot be achieved when a part of the optical train is moving relative to the rest of the optical train. Thus, the LADAR transceiver has “on-gimbal” laser cavities and bulk optics to expand, collimate, segment, and align the laser output.

The on-gimbal optical train consequently adds size, weight, complexity, and cost to the LADAR transceiver. The on-gimbal laser cavity also requires a fiber coupled laser diode pump which is a significant cost driver. Furthermore, current delivery and alignment techniques for the bulk optics are inefficient, sensitive to tolerances and temperature, and limit the output power per channel and therefore limits the signal-to-noise ratio in a multi-beam LADAR system.

The prevalence and manner of use of optical fiber in the present invention, however, permits the present invention to move the fiber laser 206 off the gimbal (not otherwise shown). More particularly, the optical fiber 106 and the delivery fiber 203 act as a waveguide for the laser signal 118 as it propagates from the fiber laser 206 to the lens form 100. Physical alignment is therefore not necessary, since the waveguide facilitates a self aligned optical delivery system. This permits additional advantages in cost, weight, complexity, and temperature and alignment sensitivities over and above those offered by the embodiments disclosed above. Furthermore, although this may lengthen the overall optical apparatus 200, the focal length of the lens form 100 is unaffected.

The present invention also permits the use of modular negative elements of varying negative power, or “variable negative elements”, in fiber laser systems for conditioning the laser signal. A small modular negative element assembly such as that provided by the invention in this embodiment has two primary advantages:
it yields a convenient line replaceable unit for fiber variations and/or facilitating the reuse of hardware or lens design form for multiple applications and various fiber laser output characteristics including but not limited to: delivery fiber NA variations, beam size/divergence/working distance requirements, operational wavelength changes, etc.; and
it provides an easily athermalized assembly where lens and housing materials and/or linkage of CTE materials and sizes can be designed to accommodate a particular rate of travel over temperature to passively athermalize the assembly to maintain collimation over extreme temperature ranges consistent with tactical environments.

Those in the art having the benefit of this disclosure will appreciate further advantages and benefits arising from this particular embodiment of the invention, as well.

Thus, in its various embodiments and aspects thereof, the present invention presents a compact collimator lens form for large mode area (“LMA”) and low numerical aperture (“NA”) fiber laser applications. This compact collimator lens form provides tactical electro-optical (“EO”) systems a small form factor for fiber delivery termination and large beam collimation. The design is reusable, scalable, and provides a common approach for applications from directed energy (“DE”) to LADAR sensors. It also employs a modular component design for accommodating different fiber NAs or mission specific output beam requirements. Various embodiments may:
reduce the overall length of the lens form used to adequately terminate and collimate a fiber laser without sacrificing beam quality or increasing beam divergence;
increase power tolerance and reduce back reflection through the negative end-cap and greater center thickness;
facilitate off-gimbal fiber laser delivery and common connector type interface in a single modular sub-assembly for volume constrained EO systems such as those in tactical LADAR or DE;
reduce parts counts;
reduce critical alignment sensitivities to improve packaging of fiber laser transmitters; and
reduce temperature sensitivities.
   Note that this list is neither exhaustive nor exclusive. Some embodiments may realize advantages or embody characteristics in addition to or in lieu of those set forth above. Note further that not all embodiments will necessarily exhibit all those characteristics listed.

The present invention therefore facilitates:
off-gimbal lasers, i.e., the tactical user of fiber lasers, side-pumped cavities or diode arrays off-gimbal and fiber coupled as lower cost, higher efficiency alternatives. Laser generated heat becomes easier to manage and space on-gimbal becomes available for multi-mode concepts.
miniaturization. Complex laser transmitter beam expansion optics for alignment and collimation may be replaced with a single line replaceable unit with a simple keyed connector attachment.
reliability enhancements, since reduced part count, shorter path length, and fewer critical surfaces result in an assembly less susceptible to contamination or defects in environments.
modularity and reuse, since it provides interface and reformatting necessary to integrate common fiber laser transmitters on multiple platforms, multi-mode seekers, and/or DE laser solutions.
upward compatibility, because it scales to higher channel counts and future fiber optic transmitter architectures with increased efficiency and better use of available space.
   Again, this list is neither exhaustive nor exclusive and not all embodiments will necessarily comport with all those concepts listed.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A lens form, comprising:
a length of optical fiber terminated on at least one end thereof;
a negative optical element optically aligned with the terminated end of the optical fiber and capable of diverging a laser signal carried by the optical fiber; and
a positive optical element optically aligned with the negative optical element and capable of collimating the laser signal diverged by the negative optical element.

2. The lens form of claim 1, wherein the length of optical fiber comprises a low numerical aperture, large mode area fiber pigtail.

3. The lens form of claim 2, wherein the length of optical fiber includes a delivery fiber.

4. The lens form of claim 1, wherein the length of optical fiber includes a delivery fiber.

5. The lens form of claim 1, wherein the negative optical element comprises a negative lens.

6. The lens form of claim 5, wherein the negative lens comprises an equi-concave lens.

7. The lens form of claim 1, wherein the negative optical element comprises a concave face on the end of an end-cap terminating the optical fiber.

8. The lens form of claim 1, wherein the negative optical element comprises a variable negative element.

9. The lens form of claim 1, wherein the positive optical element comprises a positive lens.

10. The lens form of claim 9, wherein the positive lens comprises a plano-convex lens.

11. The lens form of claim 1, wherein the positive optical element comprises a collimating lens designed for minimum spherical aberration or reduced wavefront error of the aspheric type.

12. A lens form, comprising:
an endcap;
a length of optical fiber terminated at one end thereof by the endcap;
a negative lens optically aligned with the optical fiber output path; and
a positive lens optically aligned with the negative lens.

13. The lens form of claim 12, wherein the length of optical fiber comprises a low numerical aperture, large mode area fiber pigtail.

14. The lens form of claim 12, wherein the length of optical fiber includes a delivery fiber.

15. The lens form of claim 12, wherein the negative lens comprises an equi-concave lens.

16. The lens form of claim 12, wherein the positive lens comprises a plano-convex lens.

17. The lens form of claim 12, wherein the positive lens comprises a collimating lens designed for minimum spherical aberration or reduced wavefront error of the aspheric type.

18. A lens form, comprising:
an endcap having a concave face formed in a first end thereof;
a length of optical fiber terminated at one end thereof by affixation to a second end of the endcap; and
a positive lens optically aligned with the output path of the optical fiber.

19. The lens form of claim 18, wherein the length of optical fiber comprises a low numerical aperture, large mode area fiber pigtail.

20. The lens form of claim 18, wherein the length of optical fiber includes a delivery fiber.

21. The lens form of claim 18, wherein the positive lens comprises a plano-convex lens.

22. The lens form of claim 18, wherein the positive lens comprises a collimating lens designed for minimum spherical aberration or reduced wavefront error of the aspheric type.

23. A method, comprising:
generating a high energy laser signal from a fiber laser;
receiving the laser signal at a lens form;
diverging the laser signal in the lens form to reduce the overall length thereof; and
collimating the diverged laser signal in the lens form.

24. The method of claim 23, wherein diverging the laser signal includes propagating the laser signal through a negative lens.

25. The method of claim 23, wherein diverging the laser signal includes propagating the laser signal through a concave face on the end of an end-cap.

26. The method of claim 23, wherein diverging the laser signal include propagating the laser signal through a variable negative element.

27. A lens form, comprising:
a high energy fiber laser capable of generating a laser signal;
means for receiving the laser signal at a lens form;
means for diverging the laser signal in the lens form to reduce the overall length thereof; and
means for collimating the diverged laser signal in the lens form.

28. The lens form of claim 27, wherein the receiving means comprises an endcap.

29. The lens form of claim 28, wherein the diverging means comprises a concave face on the exit end of the endcap.

30. The lens form of claim 27, wherein the diverging means comprises a negative optical element.

31. The lens form of claim 27, wherein the collimating means comprises a positive optical element.

32. A LADAR apparatus, comprising:
a laser; and
a LADAR sensor;
wherein the LADAR sensor receives a laser signal from the laser in a direction transverse to the direction in which it transmits a LADAR signal.

33. The LADAR apparatus of claim 32, further comprising a lens form through which the LADAR sensor receives the laser signal from the laser, the lens form including:
a length of optical fiber affixed to the laser at a first end and terminated on a second end thereof;
a negative optical element optically aligned with the terminated end of the optical fiber; and
a positive optical element optically aligned with the negative optical element.

34. The LADAR apparatus of claim 33, wherein the length of optical fiber comprises a low numerical aperture, large mode area fiber pigtail.

35. The LADAR apparatus of claim 33, wherein the length of optical fiber includes a delivery fiber.

36. The LADAR apparatus of claim 33, wherein the negative optical element comprises a negative lens.

37. The LADAR apparatus of claim 33, wherein the negative optical element comprises a concave face on the end of an end-cap terminating the optical fiber.

38. The LADAR apparatus of claim 33, wherein the negative optical element comprises a variable negative element.

39. The LADAR apparatus of claim 32, wherein the positive optical element comprises a plano-convex lens.

40. The LADAR apparatus of claim 32, wherein the positive optical element comprises a collimating lens designed for minimum spherical aberration or reduced wavefront error of the aspheric type.

41. The LADAR apparatus of claim 32, wherein the laser comprises a fiber laser.

42. The LADAR apparatus of claim 32, wherein the LADAR sensor is gimbaled.

43. The LADAR apparatus of claim 42, wherein the laser is off the gimbal.

44. A LADAR apparatus, comprising:
a fiber laser; and
a LADAR sensor;
a lens form through which the LADAR sensor receives the laser signal from the laser, the lens form including:
a length of optical fiber affixed to the laser at a first end and terminated on a second end thereof;
a negative optical element optically aligned with the terminated end of the optical fiber; and
a positive optical element optically aligned with the negative optical element.

45. The LADAR sensor of claim 44, wherein the length of optical fiber comprises a low numerical aperture, large mode area fiber pigtail.

46. The LADAR sensor of claim 44, wherein the length of optical fiber includes a delivery fiber.

47. The LADAR sensor of claim 44, wherein the negative optical element comprises a negative lens.

48. The LADAR sensor of claim 44, wherein the negative optical element comprises a concave face on the end of an end-cap terminating the optical fiber.

49. The LADAR sensor of claim 44, wherein the negative optical element comprises a variable negative element.

50. The LADAR sensor of claim 44, wherein the positive optical element comprises a plano-convex lens.

51. The LADAR sensor of claim 44, wherein the positive optical element comprises a collimating lens designed for minimum spherical aberration or reduced wavefront error of the aspheric type.

52. The LADAR sensor of claim 44, wherein the LADAR sensor is gimbaled.

53. The LADAR sensor of claim 52, wherein the laser is off the gimbal.

54. An optical apparatus, comprising:
a high energy fiber laser; and
a lens form, comprising:
a length of optical fiber terminated on a first end thereof and affixed to the fiber laser at a second end thereof;
a negative optical element optically aligned with the terminated end of the optical fiber; and
a positive optical element optically aligned with the negative optical element.

55. The optical apparatus of claim 54, wherein the length of optical fiber comprises a low numerical aperture, large mode area fiber pigtail.

56. The optical apparatus of claim 54, wherein the length of optical fiber includes a delivery fiber.

57. The optical apparatus claim 54, wherein the negative optical element comprises a negative lens.

58. The optical apparatus of claim 54, wherein the negative optical element comprises a concave face on the end of an end-cap terminating the optical fiber.

59. The optical apparatus of claim 54, wherein the negative optical element comprises a variable negative element.

60. The optical apparatus of claim 54, wherein the positive optical element comprises a plano-convex lens.

61. The optical apparatus of claim 54, wherein the positive optical element comprises a collimating lens designed for minimum spherical aberration or reduced wavefront error of the aspheric type.
